(19) United States
(12) Patent Application Publication
(10) Pub. No.: US 2024/0264016 A1
(43) Pub. Date: Aug. 8, 2024

(54) SENSORS AND METHODS FOR MANUFACTURING SENSORS

(71) Applicant: SHENZHEN SHOKZ CO., LTD., Shenzhen (CN)

(72) Inventors: Yongshuai YUAN, Shenzhen (CN); Yujia HUANG, Shenzhen (CN); Xin QI, Shenzhen (CN); Fengyun LIAO, Shenzhen (CN)

(73) Assignee: SHENZHEN SHOKZ CO., LTD., Shenzhen (CN)

(21) Appl. No.: 18/641,413

(22) Filed: Apr. 21, 2024

Related U.S. Application Data
(63) Continuation of application No. PCT/CN2022/093831, filed on May 19, 2022.

(51) Int. Cl. G01L 1/22

(52) U.S. Cl. CPC G01L 1/2293

(57) ABSTRACT

The present disclosure relates to a sensor including a substrate layer and an electrode layer. The substrate layer is configured to deform in response to an external force, and the electrode layer is arranged on the substrate layer. The electrode layer includes a crack structure, and a deformation of the substrate layer changes a dimension of the crack structure, thereby changing an electrical resistance of the electrode layer and generating a sensing signal changing along with the electrical resistance.

### CROSS-REFERENCE TO RELATED APPLICATIONS

This application is a continuation of International Patent Application No. PCT/CN2022/093831, filed on May 19, 2022, the contents of which are hereby incorporated by reference.

### TECHNICAL FIELD

The present disclosure relates to the field of sensing technology, and in particular, to sensors and methods for manufacturing the sensors.

### BACKGROUND

Resistive pressure sensors are the main form of pressure sensors. The sensitivity of the resistive sensors is mainly determined by a resistivity coefficient of material thereof. However, the resistivity coefficient is often limited by factors such as materials and processes, making it difficult to be significantly increased. Therefore, it is necessary to propose sensors that can overcome the limitations of materials and processes and improve the sensitivity from a structural design perspective.

### SUMMARY

Embodiments of the present disclosure provide a sensor including a substrate layer and an electrode layer. The substrate layer may be configured to deform in response to an external force, and the electrode layer may be arranged on the substrate layer. The electrode layer may include a crack structure. A deformation of the substrate layer may change a dimension of the crack structure to change an electrical resistance of the electrode layer and to generate a sensing signal changing along with the electrical resistance.

In some embodiments, the substrate layer may extend along a first direction, and the crack structure may include a plurality of first sub-cracks arranged at intervals along the first direction.

In some embodiments, the substrate layer may extend along a first direction, and the crack structure may include a plurality of second sub-cracks arranged at intervals along a second direction. Each second sub-crack of the plurality of second sub-cracks may extend along the first direction, and the second direction may be perpendicular to the first direction.

In some embodiments, the crack structure may further include a plurality of first sub-cracks distributed along the first direction.

In some embodiments, the plurality of second sub-cracks may be non-uniformly distributed in the first direction.

In some embodiments, a total count of the plurality of second sub-cracks may be within a range of 10-10000.

In some embodiments, the substrate layer may have a beam-like structure or a plate-like structure, and the first direction may be a length direction of the substrate layer.

In some embodiments, the substrate layer may have a circular membrane-like structure, and the first direction may be a radial direction of the substrate layer.

In some embodiments, each second sub-crack in a part of the plurality of second sub-cracks may have a varying width in an extension direction.

In some embodiments, the width of the each second sub-crack of a part of the plurality of first sub-cracks may be within a range of 100 nanometers-3 micrometers.

In some embodiments, a ratio of a maximum width of the each second sub-crack of a part of the plurality of second sub-cracks to a length of the substrate layer may be less than or equal to a tensile strain of the substrate layer during preparation.

In some embodiments, the electrode layer may be electrically connected to two output ends, and an included angle between a line connecting the two output ends and an extension direction of the each sub-crack may be within a range of 80 degrees-100 degrees.

In some embodiments, the each second sub-crack of a part of the plurality of second sub-cracks may be of a curved shape in an extension direction.

In some embodiments, the electrical resistance of the electrode layer may vary nonlinearly with the dimension of the crack structure.

In some embodiments, the electrode layer may include a material including a first Young's modulus, and the substrate layer includes a material including a second Young's modulus. The second Young's modulus may not exceed 1/10 of the first Young's modulus.

In some embodiments, a ratio of a thickness of the electrode layer to a thickness of the substrate layer may be within a range of 1:20-1:2

Embodiments of the present disclosure provide a method for manufacturing a sensor. The method may include fixing a material of a substrate layer in a shrinkable state on a substrate mold; depositing an electrode layer on the material of the substrate layer; patterning the electrode layer to form a crack structure in the electrode layer; and shrinking the substrate layer to reduce a dimension of the crack structure in the electrode layer.

Embodiments of the present disclosure provide a method for manufacturing a sensor. The method may include fixing a material of a substrate layer in an extensible state on a substrate mold; depositing an electrode layer on the material of the substrate layer; and extending the substrate layer to form a crack structure in the electrode layer.

Embodiments of the present disclosure provide a method for manufacturing a sensor. The method may include fixing a material of a substrate layer material to a substrate mold; depositing an electrode layer on the material of the substrate layer; and patterning the electrode layer to form a crack structure in the electrode layer.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and where:

FIG. 1 is a schematic diagram illustrating an actual contact surface of two electrode layers according to some embodiments of the present disclosure;

FIG. 2 is a block diagram illustrating an exemplary sensor according to some embodiments of the present disclosure;

FIG. 3A is a diagram illustrating a top view of an exemplary sensor according to some embodiments of the present disclosure;

FIG. 3B is a diagram illustrating a front view of an exemplary sensor according to some embodiments of the present disclosure;

FIG. 3C is an oblique axonometric drawing of an exemplary sensor according to some embodiments of the present disclosure;

FIG. 4A is a diagram illustrating a variation in electrical resistances of a sensor for different areas of crack contact surfaces according to some embodiments of the present disclosure;

FIG. 4B is a diagram illustrating a variation in electrical resistances of a sensor for different counts of crack structures according to some embodiments of the present disclosure;

FIG. 5 is a flowchart illustrating an exemplary method for manufacturing a sensor according to some embodiments of the present disclosure;

FIG. 6 is a flowchart illustrating an exemplary method for manufacturing a sensor according to some embodiments of the present disclosure;

FIG. 7 is a diagram illustrating a top view of an exemplary electrode layer according to some embodiments of the present disclosure; and

FIG. 8 is a flowchart illustrating an exemplary method for manufacturing a sensor according to some embodiments of the present disclosure.

### DETAILED DESCRIPTION

To more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that “system,” “device,” “unit,” and/or “module” as used herein is a manner used to distinguish different components, elements, parts, sections, or assemblies at different levels. However, if other words serve the same purpose, the words may be replaced by other expressions.

As shown in the present disclosure and claims, the words “one,” “a,” “a kind,” and/or “the” are not especially singular but may include the plural unless the context expressly suggests otherwise. In general, the terms “comprise,” “comprises,” “comprising,” “include,” “includes,” and/or “including,” merely prompt to include operations and elements that have been clearly identified, and these operations and elements do not constitute an exclusive listing. The methods or devices may also include other operations or elements.

The flowcharts used in the present disclosure illustrate operations that systems implement according to some embodiments of the present disclosure. It should be understood that the previous or subsequent operations may not be accurately implemented in order. Instead, each step may be processed in reverse order or simultaneously. Meanwhile, other operations may also be added to these processes, or a certain step or several steps may be removed from these processes.

The embodiments of the present disclosure provide a sensor. In some embodiments, the sensor may include a substrate layer and an electrode layer. The electrode layer may be arranged on the substrate layer, and the electrode layer may be arranged with a crack structure. In some embodiments, the substrate layer may be configured to deform in response to an external force, which in turn causes deformation of the crack structure arranged in the electrode layer arranged thereon. Thus, a dimension of the crack structure may be changed, thereby changing an electrical resistance of the electrode layer and generating a sensing signal changing along with the electrical resistance. In this case, by arranging the crack structure in the electrode layer or the substrate layer, when the substrate layer is subjected to a tensile or compressive deformation, a contact surface of the crack structure may contact with each other, and even a very small deformation may cause a contact electrical resistance of the contact surface of the crack structure to accumulate and stack, thus amplifying the small deformation in the sensor. Furthermore, by designing the dimension, position, shape, and count of the crack structure in the sensor, the crack structure may be utilized efficiently as far as possible to improve an accumulation effect of the electrical resistance. At the same time, a location prones to a fracture and a crystal orientation in the sensor may be avoided, reducing a reliability degradation caused by stress concentration. Additionally, the shape and dimension of the crack structure may be designed so that the contact surface of the crack structure may vary in a gradient with the deformation of the structure, thus controlling a slope of the electrical resistance changing with deformation, and thus improving the quality of an output signal.

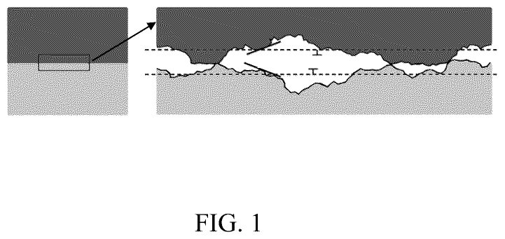

Taking two electrode layers in contact with each other as examples, a contact electrical resistance of the two electrode layers in contact with each other may be described below. FIG. 1 is a schematic diagram illustrating an actual contact surface of two electrode layers according to some embodiments of the present disclosure. In some embodiments, the two electrode layers are in contact with each other, and an actual contact surface may be smaller than a theoretical contact surface. As shown in FIG. 1, according to a smoothness degree of a surface and a magnitude of a contact pressure, a difference between the theoretical contact surface and the actual contact surface may reach several thousand times. In some embodiments, the actual contact surface may be divided into two portions. One is a portion of the electrode layer where metals are in direct contact, which is a contact micro point with no transition electrical resistance between the metals. Another is a portion of the electrode layer that contacts each other after passing through non-metallic material (e.g., a thin film contaminant formed on the contact surface of the electrode layer) at a contact interface of the electrode layer.

In some embodiments, the electrical resistance shown in the electrode layer as the current passes through an actual contact surface due to the contraction (or concentration) of the current line may be referred to as a concentration electrical resistance. An electrical resistance formed by a membrane layer of the contact surface and a membrane layer constructed by other contaminants may be referred to as a membrane layer electrical resistance. An electrical resistance of a conductor in the electrode layer may be referred to as a conductor electrical resistance. Thus, an actual total contact electrical resistance R of the contact surface of the two electrode layers may be divided into three portions including a centralized electrical resistance RC, a membrane layer electrical resistance Rf, and a conductor electrical resistance Rp, as shown in following equation:

$$R = {R}_{C} + {R}_{f} + {R}_{p} = {R}_{j} + {R}_{p} , \qquad ( 1 )$$

where a combined electrical resistance of the centralized electrical resistance RC and the membrane layer electrical resistance Rf may be referred to as the actual contact electrical resistance Rj.

In some embodiments, the conductor electrical resistance Rp in the electrode layer may be determined by the nature of the material of the conductor, a length, a thickness (cross-sectional area), and a temperature. For example, the conductor electrical resistance Rp may be determined based on equation (2):

$${R}_{p} = ρ \frac{L}{S} , \qquad ( 2 )$$

where ρ denotes resistivity, which is a parameter that describes electrical conductivity, and is related to the temperature, L denotes the length of the conductor, and S denotes the cross-sectional area of the conductor.

In some embodiments, the actual contact electrical resistance Rⱼ may be determined based on equation (3):

$${R}_{j} = \frac{K}{{F}^{m}} , \qquad ( 3 )$$

where K denotes a constant related to a contact material, a condition of the contact surface, and a processing manner of the contact surface, F denotes a contact pressure, and m denotes a constant related to a contact form. For example, for a point contact, the constant m may be within a range of 0.5-0.7. As another example, for a face contact, the constant m may be equal to 1. In some embodiments, the actual contact electrical resistance Rⱼ may be calculated by measuring the contact voltage drop. From equations (1)-(3), the actual total contact electrical resistance between the electrode layers is related to the actual contact surface. In some embodiments, the actual contact surface between the electrode layers may relate to parameters such as a ratio of a thickness of the substrate layer to a thickness of the electrode layer, the dimension, shape, distribution, and count of the crack structure between the electrode layers. Therefore, the actual total contact electrical resistance between the electrode layers may be adjusted by adjusting the parameters such as the ratio of the thickness of the substrate layer to the thickness of the electrode layer, the dimension, shape, distribution, and count of the crack structure between the electrode layers.

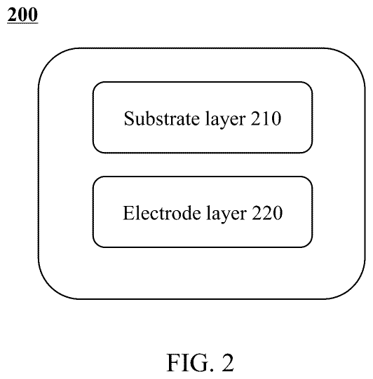

FIG. 2 is a block diagram illustrating an exemplary sensor according to some embodiments of the present disclosure.

The sensor 200 may be a component including a piezoresistive effect. For example, when the sensor is subjected to stress, the electrical resistance of the sensor 200 may change with the change in stress, and the sensor 200 may generate an electrical signal based on the change in electrical resistance. As shown in FIG. 2, the sensor 200 may include a substrate layer 210 and an electrode layer 220.

In some embodiments, the substrate layer 210 may be configured to deform under an external force. In some embodiments, a Young's modulus of a material of the substrate layer 210 may be set within a certain range to allow the substrate layer 210 to deform a moderate amount under the external force. In some embodiments, the Young's modulus of the material of the substrate layer 210 may be within a range of 1 kPa-50 GPa. For example, the Young's modulus of the material of the substrate layer 210 may be within a range of 100 kPa-20 GPa. As another example, the Young's modulus of the material of the substrate layer 210 may be within a range of 500 kPa-5 GPa. In some embodiments, the material of the substrate layer 210 may be a flexible material. For example, the material of the substrate layer 210 may include polyimide (PI), polydimethylsiloxane (PDMS), polymethylmethacrylate (PMMA), etc., or any combination thereof. In some embodiments, the material of the substrate layer 210 may allow the substrate layer 210 to shrink and deform perpendicular to a stretching direction when the substrate layer 210 is in a stretched state. For example, the material of the substrate layer 210 may be a material of positive Poisson's ratio. Exemplary materials with the positive Poisson's ratios may include polyimide (PI), polydimethylsiloxane (PDMS), polymethylmethacrylate (PMMA), etc., or any combination thereof. In some embodiments, the material of the substrate layer 210 may cause the substrate layer 210 to elongate (or expand) and deform perpendicular to the stretching direction when in the stretched state. For example, the material of the substrate layer 210 may include a material of negative Poisson's ratio. Exemplary materials with negative Poisson's ratios may include metamaterials with negative Poisson's ratio, etc.

In some embodiments, the substrate layer 210 may be a structure that extends in a particular direction (e.g., a first direction). For example, the substrate layer 210 may be a beam-like structure, and the first direction may be a length direction of the substrate layer 210 (i.e., a long axis direction of the beam-like structure). As another example, the substrate layer 210 may be a plate-like structure, and the first direction may be a length direction of the substrate layer 210 (i.e., a long axis direction of the plate-like structure). As another example, the substrate layer 210 may be a circular membrane-like structure, and the first direction may be a radial direction of the substrate layer 210 (i.e., a radial direction of the circular membrane-like structure).

In some embodiments, the electrode layer 220 may be arranged on the substrate layer 210 configured to transmit an electrical signal. In some embodiments, the electrode layer 220 may be arranged with a crack structure. The crack structure may be distributed on a surface opposite a contact surface, extending or not extending to the contact surface. The contact surface refers to a surface of the electrode layer 220 contacts with the substrate layer 210. In some embodiments, the deformation of the substrate layer 210 may change a dimension of the crack structure on the electrode layer 220, thereby changing the electrical resistance of the electrode layer 220. In some embodiments, the sensor 200 may generate a sensing signal that changes with the electrical resistance. The dimension of the crack structure described in the present disclosure refers to a projection area of the crack structure on a surface of the electrode layer 220 (i.e., on the surface of the electrode layer 220 opposite the contact surface with the substrate layer 210).

In some embodiments, the electrode layer 220 may be an electrically conductive device that transmits the electrical signal. In some embodiments, the material of the electrode layer 220 may be a conductive material. Exemplary conductive materials may include copper (Cu), platinum (Pt), iron (Fe), carbon (C), graphite, etc., or any combination thereof.

In some embodiments, a Young's modulus of the material of the electrode layer 220 may affect the closing and opening of the contact surface of the crack structure. In some embodiments, to make the deformation of the substrate layer 210 to change the dimension of the crack structure on the electrode layer 220, the Young's modulus of the material of the electrode layer 220 may be within a range of 10 GPa-350 GPa. For example, the Young's modulus of the material of the electrode layer 220 may be within a range of 30 GPa-320 GPa. As another example, the Young's modulus of the material of the electrode layer 220 may be within a range of 50 GPa-300 GPa.

In some embodiments, the material of the electrode layer 220 may be different from the material of the substrate layer 210. For example, the electrode layer 220 may include a material having a first Young's modulus, and the substrate layer 210 may include a material having a second Young's modulus. In some embodiments, the second Young's modulus may be less than the first Young's modulus. For example, the second Young's modulus may be no more than ¼ of the first Young's modulus. As another example, the second Young's modulus may be no more than ⅕ of the first Young's modulus. As another example, the second Young's modulus may be no more than 1/10 of the first Young's modulus.

In some embodiments, the crack structure may be a sum of all the slit structures on the electrode layer 220. In some embodiments, the crack structure may include a plurality of sub-cracks. In some embodiments, on the electrode layer 220, the plurality of sub-cracks may be distributed on surfaces opposite to the contact surface, extending or not extending to the contact surface. In some embodiments, the plurality of sub-cracks may be arranged at intervals. In some embodiments, the crack structure may include a plurality of sub-cracks arranged at intervals along a particular direction (e.g., a plurality of first sub-cracks arranged along a first direction and a plurality of second sub-cracks arranged along a second direction). As described above, when the substrate layer 210 is the beam-like structure or the plate-like structure, the first direction may be the length direction (i.e., the long axis direction) of the substrate layer 210.

In some embodiments, the crack structure may include the plurality of first sub-cracks arranged at intervals along the length direction (i.e., the long axis direction) of the substrate layer 210. As another example, when the substrate layer 210 is the circular membrane-like structure, the first direction may be the radial direction of the substrate layer 210, and the crack structure may include a plurality of first sub-cracks arranged at intervals along the radial direction of the substrate layer 210. In some embodiments, the plurality of first sub-cracks in the crack structure may extend along the second direction. In some embodiments, when the substrate layer 210 is the beam-like structure or the plate-like structure, the second direction may be a width direction (i.e., a short axis direction) of the substrate layer 210, and the plurality of first sub-cracks in the crack structure may extend along the width direction of the substrate layer 210. As another example, when the substrate layer 210 is the circular membrane-like structure, the second direction may be a circumferential direction of the substrate layer 210, and the plurality of first sub-cracks in the crack structure may extend along the circumferential direction of the substrate layer 210. Merely by way of example, when the crack structure is arranged at intervals along the length direction of the substrate layer 210 and extends along the width direction of the substrate layer 210, deformation of the substrate layer 210 in the length direction (e.g., tensile deformation or compressive deformation) may change a width of the crack structure, thereby changing the dimension of the crack structure, and changing the electrical resistance of the electrode layer 220.

In some embodiments, when the substrate layer 210 is the beam-like structure or the plate-like structure, the crack structure may include the plurality of second sub-cracks arranged at intervals along the second direction (i.e., the width direction or the short axis direction) of the substrate layer 210, and the plurality of second sub-cracks may extend along the first direction (i.e., the length direction or the long axis direction). In some embodiments, when the substrate layer 210 is a circular membrane-like structure, the crack structure may include a plurality of second sub-cracks arranged at intervals along the second direction (i.e., the circumferential direction) of the substrate layer 210, and the plurality of second sub-cracks may extend along the first direction (i.e., the radial direction). Merely by way of example, when the crack structure is arranged at intervals along the width direction of the substrate layer 210 and extends along the length direction of the substrate layer 210, deformation (e.g., tensile deformation or compressive deformation) of the substrate layer 210 in the length direction may cause deformation of the substrate layer 210 in the width direction as well, thereby changing the width of the crack structure, and changing the electrical resistance of the electrode layer 220. As previously described, when the substrate layer 210 is in the stretched state in the length direction, it may undergo an expansion deformation or a contraction deformation in the width direction. When the expansion deformation also occurs in the width direction (e.g., when the substrate layer 210 is made of the material with the negative Poisson's ratio), the crack structure may be compressed, the width of the crack structure may decrease accordingly, and the electrical resistance of the electrode layer 220 may be smaller as a result. When the contraction deformation occurs in the width direction, the width of the crack structure may increase accordingly, and the electrical resistance of the electrode layer 220 may increase as a result.

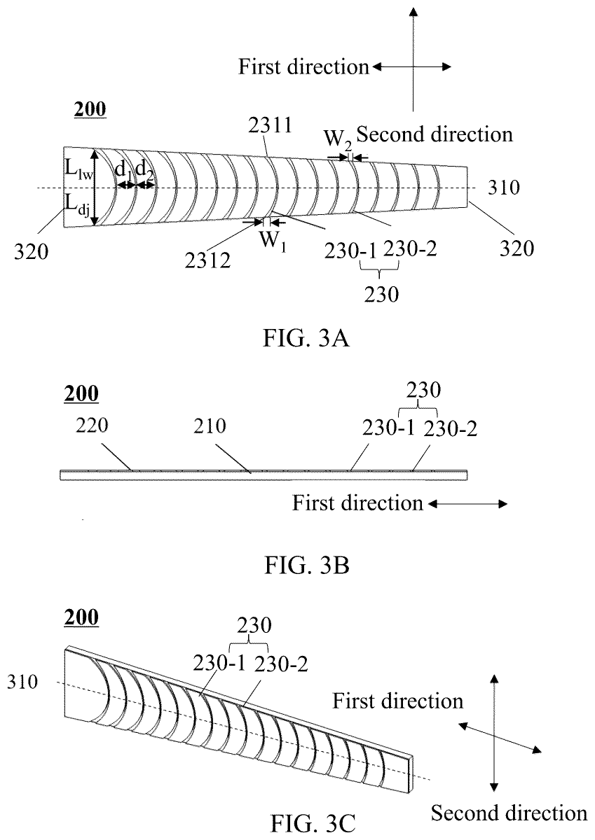

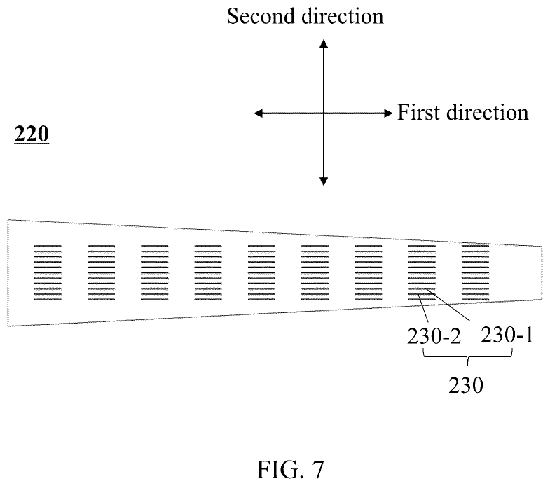

In some embodiments, the crack structure may include an array of first sub-cracks arranged at intervals along the first direction and an array of second sub-cracks arranged at intervals along the second direction of the substrate layer, and the plurality of sub-cracks (including the first sub-cracks and the second sub-cracks) may extend along the first direction. Exemplary structures and arrangements of the sub-cracks may be found in FIG. 3A-FIG. 3C and FIG. 7 of the present disclosure and related descriptions.

In some embodiments, the plurality of sub-cracks may be uniformly distributed in the first direction or the second direction. For example, a distance between two adjacent sub-cracks in the plurality of sub-cracks may be the same along the first direction or the second direction. The distance between the two adjacent sub-cracks may be a distance between centers of the two adjacent sub-cracks. In some embodiments, the center of the sub-crack refers to a center of a line connecting two intersections of a projection shape of the sub-crack on the surface of the electrode layer 220 and a median axis of the substrate layer 210 (a median axis of the substrate layer 210 perpendicular to the second direction). In some embodiments, the center of the sub-crack refers to a geometric center of the projection shape of the sub-crack on the surface of the electrode layer 220. In some embodiments, the plurality of sub-cracks may be unevenly distributed in the first direction or the second direction. For example, in some embodiments, stresses at different parts of the substrate layer 210 may be different. When the substrate layer 210 is fixed to other components (e.g., a vibration component that provides an external force), the stresses on the substrate layer 210 may be different in a region near a fixed end, in a region near a free end, and in an intermediate region in addition to the above two regions. For example, the stress in the region near the fixed end may be greater than that in the region near the free end (or the intermediate region). In some embodiments, to reduce the risk of fracture due to stress concentration in a region of higher stress and to increase the reliability of the sensor 200, the distance between the two adjacent sub-cracks in the plurality of sub-cracks on the region of higher stress (e.g., the region near the fixed end) may be greater than the distance between the two adjacent sub-cracks on a region of lower stress (e.g., the region near the free end). In some embodiments, the plurality of sub-cracks may be unequally spaced on the region of higher stress (e.g., the region near the fixed end). The plurality of sub-cracks may be equidistantly spaced on the region of lower stress (e.g., the regions near the free end or the intermediate region). In some embodiments, compared to sub-cracks in the region of lower stress, sub-cracks in the region of higher stress may be more prone to deformation, changes in the electrical resistance may be more significant, and a change rate of the sensing signal may be larger. In some embodiments, a deformation degree of the sub-cracks in the region of higher stress may be further increased to make the change rate of the sensing signal generated by a small deformation more significant and make the sensing signal measured. Thus the distance between two adjacent sub-cracks in the plurality of sub-cracks in the region of higher stress may be less than the distance between two adjacent sub-cracks in the region of lower stress (i.e., the sub-cracks in the region with higher stress may be more densely arranged than the sub-cracks in the region with lower stress). In some embodiments, the plurality of two adjacent sub-cracks may be equally spaced on the region of higher stress (e.g., the region near the fixed end). The plurality of two adjacent sub-cracks may be unequally spaced on the region of lower stress (e.g., the region near the free end or the intermediate region). It should be understood that the plurality of sub-cracks may be distributed on the electrode layer 220, and the region of higher stress or the region of lower stress that is distributed on the substrate layer 210 as described in the present disclosure refers to a corresponding region on the electrode layer 220.

In some embodiments, the plurality of sub-cracks may be distributed over the entire surface of electrode layer 220. In some embodiments, the plurality of sub-cracks may be distributed over only a part of the surface. For example, to reduce the risk of fracture due to stress concentration in the region of higher stress and to increase the reliability of the sensor 200, the plurality of sub-cracks may not be distributed in the region of higher stress (e.g., the region near the fixed end), while the plurality of sub-cracks may be distributed in the region of lower stress (e.g., the region near the free end).

In some embodiments, the plurality of sub-cracks may be one or more of a straight line, a folded line, a circular arc, or other curves, etc., in an extension direction. For example, when the plurality of sub-cracks extend in the first direction, the plurality of sub-cracks may be one or more of the straight line, the folded line, the circular arc, or other curves, etc., along the first direction. As another example, when the plurality of sub-cracks extend along the second direction, the plurality of sub-cracks may be one or more of the straight line, the folded line, the circular arc, or other curves, etc., along the second direction. In some embodiments, each sub-crack in a part of the plurality of sub-cracks may have the same or a different shape along the extension direction. In some embodiments, to reduce the risk of fracture due to stress concentration in the region of higher stress, the shape of the sub-crack in the extension direction may be curved or folded in the region of higher stress (e.g., the region near the fixed end). In the region of lower stress (e.g., the region near the free end or the intermediate region), the shape of the sub-crack in the extension direction may be straight. In some embodiments, to make the change rate of the sensing signal generated by the small deformation more significant, and thus measure the sensing signal, the deformation degree of the sub-cracks in the region of higher stress may be further increased, and thus the shape of the sub-cracks in the extension direction may be the straight line in the region of higher stress (e.g., the region near the fixed end). The shape of the sub-cracks in the extension direction may be a curve or a fold line in the region of lower stress (e.g., the region near the free end or the intermediate region).

In some embodiments, a length of each sub-crack in the plurality of sub-cracks in the extension direction may be equal to a length of the electrode layer 220 at a corresponding location in the extension direction. For example, for the beam-like structure or the plate-like structure, when the plurality of sub-cracks extend in the second direction, the length of the electrode layer 220 at the corresponding location in the second direction may be a width of the electrode layer 220, i.e., along the second direction, the plurality of sub-cracks may run through the entire electrode layer 220. When the plurality of sub-cracks extend along the first direction, the length of the electrode layer 220 at the corresponding location in the first direction may be a length of the electrode layer 220, i.e. Along the first direction, the plurality of sub-cracks may run through the entire electrode layer 220. As another example, for the circular membrane-like structure, when the plurality of sub-cracks extends along the second direction, the length of the electrode layer 220 at the corresponding location in the second direction is a circumference of the electrode layer 220, i.e., along the second direction, the plurality of sub-cracks may run through the entire electrode layer 220. When the plurality of sub-cracks extend along the first direction, the electrode layer 220 at the corresponding location in the first direction may be a radius length of the electrode layer 220, i.e., along the first direction, the plurality of sub-cracks may extend transversely through the entire electrode layer 220. In some embodiments, each sub-crack in the plurality of sub-cracks may have a length in the extension direction that is less than the length of the electrode layer 220 at the corresponding location in the extension direction. In some embodiments, the length of a part of the plurality of sub-cracks in the extension direction may be equal to the length of the electrode layer 220 at the corresponding location in the extension direction, and the length of the remaining part of the plurality of sub-cracks in the extension direction may be less than the length of the electrode layer 220 at the corresponding location in the extension direction. For example, to reduce the risk of fracture due to stress concentration in the region of higher stress, in the region of higher stress (e.g., the region near the fixed end), the length of each sub-crack along the extension direction may be less than the length of the electrode layer 220 at the corresponding location in the extension direction. In the region of lower stress (e.g., the region near the free end or the intermediate region), the length of each sub-crack along the extension direction may be equal to the length of the electrode layer 220 at the corresponding location in the extension direction. In some embodiments, to make the change rate of the sensing signal generated by the small deformations more significant and thus measure the sensing signal, the deformation degree of the sub-cracks in the region of higher stress may be further increased. Thus, in the region of higher stress (e.g., the region near the fixed end), the length of each sub-crack along the extension direction may be equal to the length of the electrode layer 220 at the corresponding location in the extension direction. In the region of lower stress (e.g., the region near the free end or the intermediate region), the length of the sub-crack along the extension direction may be less than the length of the electrode layer 220 at the corresponding location in the extension direction.

In some embodiments, each sub-crack in the plurality of sub-cracks may have the same width. In the present disclosure, when the plurality of sub-cracks extend along the second direction, the width of each sub-crack may refer to a width of a projection of a sub-crack on the electrode layer 220 along the first direction. When the plurality of sub-cracks extend along the first direction, the width of each sub-crack may refer to a width of a projection of a sub-crack on the electrode layer 220 along the second direction. In some embodiments, each sub-crack may have a varying width in the extension direction, and thus comparisons of the widths between different sub-cracks in the present disclosure refer to comparisons of the maximum of the widths of the projections of each sub-crack. In some embodiments, each sub-crack in a part of the plurality of sub-cracks may also have unequal widths in the extension direction. In some embodiments, to reduce the risk of fracture due to excessive stress in the region of higher stress, the width of each sub-crack in the region of higher stress (e.g., the region near the fixed end) may be less than the width of each sub-crack in the region of lower stress (e.g., the region near the free end or the intermediate region). In some embodiments, to make the change rate of the sensing signal generated by the small deformation more significant and thus measure the sensing signal, the deformation degree of the sub-cracks in the region of higher stress may be further increased, and thus the width of each sub-crack in the region of higher stress (e.g., the region near the fixed end) may be greater than the width of each sub-crack on the region of lower stress (e.g., the region near the free end or the intermediate region).

In some embodiments, each sub-crack in a part of the plurality of sub-cracks may have the same width in the extension direction. In some embodiments, to make sure that contact surfaces of the sub-cracks do not come out of contact at the same time as the substrate layer 210 undergoes the tensile deformation, but rather that a contact pressure becomes progressively less as a tensile strain increases and the contact surfaces gradually come out of contact, ensuring that a contact electrical resistance of the contact surfaces of the sub-cracks gradually varies, each sub-crack in a part of the plurality of sub-cracks may have a varying width in the extension direction. For example, as the sub-cracks extend in the second direction, the width of each sub-crack may be greatest at one endpoint, gradually decrease along the extension direction of the sub-cracks to a minimum width at the median axis of the substrate layer 210 (the median axis of the substrate layer 210 perpendicular to the second direction), and then gradually increase to a maximum at the other endpoint. As another example, as the sub-cracks extend in the second direction, the width of each sub-crack may be minimal at one endpoint, gradually increase in the extension direction of the sub-cracks (i.e., the second direction) to a maximum width at the median axis of the substrate layer 210 (the median axis of the substrate layer 210 perpendicular to the second direction), and then gradually decrease to a minimum at the other endpoint. As another example, as the sub-cracks extend in the first direction, the width of each sub-crack may be greatest at one endpoint, gradually decrease in the extension direction of the sub-cracks to a minimum width at the median axis of the substrate layer 210 (the median axis of the substrate layer 210 perpendicular to the first direction), and then gradually increase to a maximum at the other endpoint. As yet another example, each sub-crack may have other regular or irregular shapes, as long as it may have a varying width in the extension direction.

In some embodiments, taking into account the preparation or manufacturing process and the deformation limit of the substrate layer 210, the width of each sub-crack in a part of the plurality of sub-cracks may be within a range of 10 nanometers-10 micrometers. For example, the width of each sub-crack in a part of the plurality of sub-cracks may be within a range of 50 nanometers-5 microns. For example, the width of each sub-crack in a part of the plurality of sub-cracks may be within a range of 100 nanometers-3 microns.

In some embodiments, to ensure that the sub-cracks may be closed after removing the tensile stress during the preparation or manufacturing of the substrate layer 210, and further to ensure the sub-cracks may change the electrical resistance of the electrode layer 220 under a deformation effect of the substrate layer 210, a ratio of a maximum width of each sub-crack in a part of the plurality of sub-cracks to the length of the substrate layer 210 may be less than or equal to the tensile strain of the substrate layer 210 during preparation or manufacturing. For example, the ratio of the maximum width of each sub-crack in a part of the plurality of sub-cracks to the length of the substrate layer 210 may be less than or equal to the tensile strain of the substrate layer 210 during preparation or manufacturing. As another example, the ratio of the maximum width of each sub-crack in a part of the plurality of sub-cracks to the length of the substrate layer 210 may be less than or equal to the tensile strain of the substrate layer 210 during preparation or manufacturing, and a ratio of a maximum width of each sub-crack in the remaining part of the plurality of sub-cracks to the length of the substrate layer 210 may be greater than the tensile strain of the substrate layer 210 during preparation or manufacturing. The electrical resistance of the electrode layer 220 may further be varied as long as it is ensured that there are sub-cracks on the electrode layer 220 that are capable of being closed.

In some embodiments, a count of the sub-cracks may be determined based on a required changing amount of the electrical resistance. In some embodiments, the greater the count of sub-cracks, the greater the changing amount of electrical resistance in the electrode layer 220. When a total count of sub-cracks in the crack structure 230 is excessively large, the reliability of the electrode layer 220 may decrease, the noise may increase, and may even lead to fracture of the electrode layer 220. In some embodiments, to reduce the risk of fracture due to stress concentration in the region of higher stress and to reduce noise, a count density of the sub-cracks in the region of higher stress (e.g., the region near the fixed end) may be less than a count density of the sub-cracks in the region of lower stress (e.g., the region near the free end or the intermediate region). The count density of sub-cracks in the present disclosure may be a ratio of the count of sub-cracks in a region on the electrode layer 220 to a length of the region along the first direction. In some embodiments, to ensure the change amount of the electrical resistance of the electrode layer 220 is large enough to detect the sensing signal, the count density of sub-cracks in the region of higher stress (e.g., the region near the fixed end) may be greater than or equal to the count density of the sub-cracks in the region of lower stress (e.g., the region near the free end or the intermediate region). In some embodiments, the count of sub-cracks may be within a range of 5-1000000 to balance factors such as the change amount of electrical resistance, the reliability, and the noise, etc. For example, the count of sub-cracks may be within a range of 7-500000. As another example, the count of sub-cracks may be within a range of 8-50000. As another example, the count of sub-cracks may be within a range of 10-10000.

In some embodiments, a thickness of the electrode layer 220 and a thickness of the substrate layer 210 may determine how easy the closing and opening of the contact surfaces of the sub-cracks are. In some embodiments, to make it easy for the sub-cracks to close during the preparation or manufacturing of the substrate layer 210 and to open easily under the deformation of the substrate layer 210, a ratio of the thickness of the substrate layer 210 to the electrode layer 220 may be within a range of 1:1-100:1. For example, the ratio of the thickness of the substrate layer 210 to the thickness of the electrode layer 220 may be within a range of 2:1-50:1. As another example, the ratio of the thickness of the substrate layer 210 to the thickness of the electrode layer 220 may be within a range of 2:1-20:1.

In some embodiments, the electrode layer 220 may be electrically connected to two output ends to output the sensing signal that changes along with electrical resistance. In some embodiments, the electrical connection may include but is not limited to, leads, coatings, etc. A line connecting the two output ends may be used to indicate a direction of the current in the electrode layer 220. In some embodiments, there may be an included angle between the line connecting the two output ends (i.e., the direction of the current in the electrode layer 220) and the extension direction of the sub-cracks. For example, the included angle between the line connecting the two output ends and the extension direction of the sub-cracks may be within a range of 80 degrees-100 degrees. As another example, the included angle between the line connecting the two output ends and the extension direction of the sub-crack may be 90 degrees, i.e., the line connecting the two output ends (i.e., the direction of the current in the electrode layer 220) may be perpendicular to the extension direction of the sub-cracks. For example, when the plurality of sub-cracks extend in the second direction, the line connecting the two output ends (i.e., the direction of the current in the electrode layer 220) may be parallel to the first direction and perpendicular to the second direction. As another example, when the plurality of sub-cracks extend along the first direction, the line connecting the two output ends (i.e., the direction of the current in the electrode layer 220) may be parallel to the second direction and perpendicular to the first direction.

In some embodiments of the present disclosure, by arranging the crack structure including a plurality of sub-cracks in the electrode layer 220, changing the dimension of the crack structure by the deformation of the substrate layer 210, the contact surfaces between the sub-cracks may come into contact with each other. Even a very slight deformation may result in a cumulative superposition of the contact electrical resistance of the contact surfaces of the plurality of sub-cracks, which may be characterized by a change in a larger electrical signal.

FIG. 3A is a diagram illustrating a top view of an exemplary sensor according to some embodiments of the present disclosure. FIG. 3B is a diagram illustrating a front view of an exemplary sensor according to some embodiments of the present disclosure. FIG. 3C is an oblique axonometric drawing of an exemplary sensor according to some embodiments of the present disclosure.

As described in FIG. 2, a substrate layer 210 may have a different structure. For illustrative purposes, FIG. 3A-FIG. 3C may be illustrated by taking an example of the substrate layer 210 of the sensor 200 being of a beam-like structure. A first direction is a length direction (i.e., a long axis direction) of the substrate layer 210, and a second direction is a width direction (i.e., a short axis direction) of the substrate layer 210. As shown in FIG. 3A-FIG. 3C, the electrode layer 220 is arranged on the substrate layer 210, and the substrate layer 210 may be extended in the first direction. The electrode layer 220 may be arranged with a crack structure 230. The crack structure 230 may include a plurality of first sub-cracks such as sub-crack 230-1, sub-crack 230-2, etc. Arranged at intervals along the first direction. The plurality of first sub-cracks may be evenly distributed in the first direction. A distance between two adjacent first sub-cracks along the first direction (a distance between centers of the two adjacent first sub-cracks) may be the same. As shown in FIG. 3A, a first distance d1 between two adjacent first sub-cracks along the first direction may be equal to a first distance d2 between two other first sub-cracks along the first direction. The center of the first sub-crack refers to a center of a line connecting two intersections of a projection shape of the first sub-crack on a surface of the electrode layer 220 and a median axis of the substrate layer 210 (a median axis of the substrate layer 210 perpendicular to the second direction). Each first sub-crack (e.g., the sub-crack 230-1 or the sub-crack 230-2) of the plurality of sub-cracks may extend in the second direction, and the plurality of first sub-cracks (e.g., the sub-crack 230-1 or the sub-crack 230-2) may be curvilinear in the extension direction thereof (i.e., the second direction). As shown in FIG. 3A, a length Llw of the plurality of first sub-cracks (e.g., the sub-crack 230-1 or the sub-crack 230-2) in the extension direction (i.e., the second direction) may be equal to a length Ldj of the electrode layer 220 at a corresponding location in the second direction, i.e., the plurality of first sub-cracks may run transversely through the entire electrode layer 220. In some embodiments, each sub-crack in a part of the plurality of first sub-cracks may be unequal in width along the first direction. As shown in FIG. 3A, a width W1 of the sub-crack 230-1 along the first direction and a width W2 of the sub-crack 230-2 along the first direction may not be equal. For example, the width W1 of the sub-crack 230-1 along the first direction near one end 320 of the sensor 200 may be greater than the width W2 of the sub-crack 230-2 along the first direction near the other end 330 of the sensor 200. In some embodiments, the first sub-cracks (e.g., the sub-crack 230-1 or the sub-crack 230-2) may have a varying width along the first direction in the extension direction (i.e., the second direction). As shown in FIGS. 3A and 3C, in the case of the sub-crack 230-1, for example, the width of the first sub-crack 230-1 may be greatest at an endpoint 2311, gradually decrease in the extension direction of the sub-crack (i.e., the second direction), minimize in width at the median axis 310 of the substrate layer 210 (the median axis of the substrate layer 210 perpendicular to the second direction), then gradually increase, and maximize at another endpoint 2312. It should be understood that the sensor 200 shown in FIG. 3A-FIG. 3C is only exemplary and does not limit the scope of protection of the present disclosure.

For the sensor 200 shown in FIGS. 3A-FIG. 3C, the first sub-cracks may extend in the second direction, and when the substrate layer 210 undergoes tensile deformation in the first direction, the width of each first sub-crack (e.g., the sub-crack 230-1 or the sub-crack 230-2) in the crack structure 230 may change in the first direction. Thus, the dimension of the crack structure may be changed, thereby changing an electrical resistance of the electrode layer 220 and generating a sensing signal that changes along with the electrical resistance.

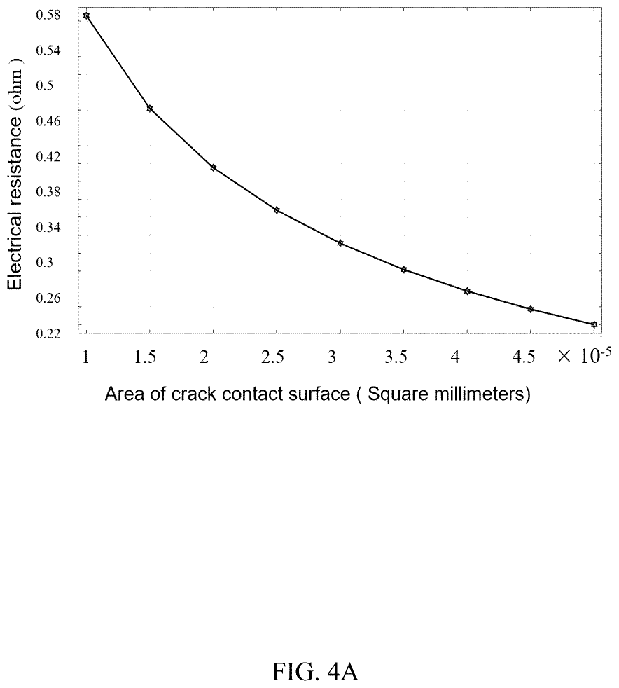

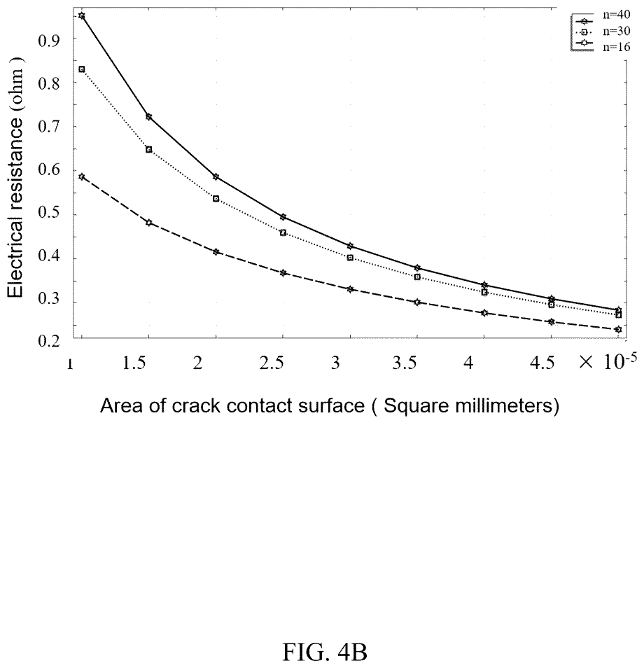

FIG. 4A is a diagram illustrating a variation in electrical resistances of a sensor for different areas of crack contact surfaces according to some embodiments of the present disclosure. FIG. 4B is a diagram illustrating a variation in electrical resistances of a sensor for different counts of crack structures according to some embodiments of the present disclosure. A horizontal coordinate may represent the dimension of the crack structure in square millimeters, a vertical coordinate may represent the electrical resistance of the sensor in ohms, and n in FIG. 4B may represent a total count of sub-cracks (e.g., the first sub-cracks arranged along the first direction and the second sub-cracks arranged along the second direction) in units of count. In some embodiments, the area of the crack contact surface may be inversely proportional to the dimension of the crack structure. For example, the larger the dimension of the crack structure, the smaller the area of the crack contact surface. Thus, the variation in the electrical resistance of the sensor at different areas of the crack contact surfaces may reflect the variation in the electrical resistance of the sensor of the crack structures with different dimensions.

As shown in FIG. 4A, the electrical resistance of the sensor 200 gradually decreases as the area of the crack contact surface increases and the dimension of the crack structure gradually decreases, while ensuring that other conditions (e.g., the count of sub-cracks, a shape, a location, etc.) remain constant. The electrical resistance of the sensor 200 (or the electrode layer 220) may vary nonlinearly with the dimension of the crack structure or the area of the crack contact surface. As shown in FIG. 4A, a change rate of the electrical resistance of the sensor 200 is gradually smaller (i.e., the curve becomes gradually flatter with a decreasing slope) for each 0.5×10⁵ mm² increase in the area of the crack contact surface, with a corresponding decrease in the dimension of the crack structure. The area of the crack contact surface may increase from 1×10⁻⁵ square millimeters to 5×10⁻⁵ square millimeters, the dimension of the crack structure may decrease accordingly, and the electrical resistance of the sensor 200 may decrease from about 0.58 ohms to about 0.24 ohms. It may be seen that the variation in the electrical resistance of the sensor 200 may be of an order of ohms. If a voltage of an order of millivolts is applied, a current in a circuit may be of an order of milliamperes. The sensor 200 operates at a current of an order of a hundred microamps. Thus, with the sensor 200 designed according to some embodiments of the present disclosure, the resistive variation may produce a sensing signal that may be effectively measured. Additionally, the sensing signal may be adjusted by increasing or decreasing the dimension of the crack structure.

When the count of sub-cracks in the crack structure is changed, i.e., the total count n of sub-cracks is 16, 30, and 40, graphs of variation in the electrical resistance of the sensor for the crack structures with different dimensions are shown in FIG. 4B. As may be seen from each curve, similar to FIG. 4A, the electrical resistance of the sensor 200 (or the electrode layer 220) varies nonlinearly with the dimension of the crack structure. Comparing the three curves, it may be seen that the electrical resistance of the sensor may gradually increase with the increase in the count n of sub-cracks when the area of the crack contact surface (or the dimension of the crack structure) is the same. When the count of sub-cracks n is increased from 16 to 40, the electrical resistance of the sensor 200 may be increased from about 0.6 ohm to about 0.95 ohm. In such a case, the change amount of the electrical resistance of the sensor 200 may be of the order of ohms, and the sensing signal generated by the variation in the electrical resistance may be effectively measured. Moreover, the sensing signal may be adjusted by increasing or decreasing the count of sub-cracks.

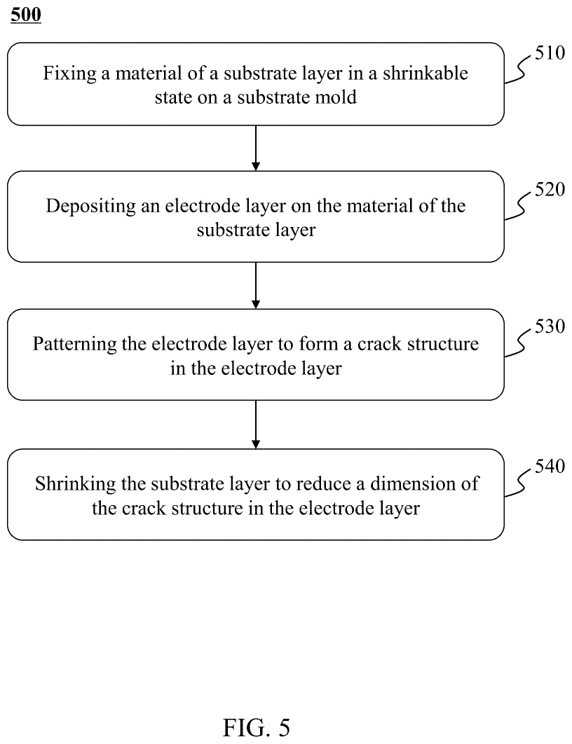

FIG. 5 is a flowchart illustrating an exemplary method for manufacturing a sensor according to some embodiments of the present disclosure. As shown in FIG. 5, process 500 includes the following operations.

In 510, a material of a substrate layer may be fixed in a shrinkable state to a substrate mold. In some embodiments, the material of the substrate layer may be stretched and then fixed to the substrate mold. In some embodiments, the material of the substrate layer that is shrinkable under certain process conditions (e.g., extrusion, reduced temperature, etc.) may be selected to be fixed to the substrate mold.

In some embodiments, the material of the substrate layer may have a certain Young's modulus. In some embodiments, the Young's modulus of the material of the substrate layer may be within a range of 1 kPa-50 GPa. For example, the Young's modulus of the material of the substrate layer may be within a range of 100 kPa-20 GPa. As another example, the Young's modulus of the material of the substrate layer may be within a range of 500 kPa-5 GPa. In some embodiments, the material of the substrate layer may be a flexible material. For example, the material of the substrate layer may include polyimide (PI), polydimethylsiloxane (PDMS), polymethylmethacrylate (PMMA), etc., or any combination thereof.

In some embodiments, the substrate mold refers to a mold used in constructing the substrate layer. In some embodiments, the substrate mold may be determined based on a structure of the substrate layer. For example, if the substrate layer is of a plate-like structure, a mold that allows a finished product to be the plate-like structure may be selected as the substrate mold.

In 520, an electrode layer may be deposited on the material of the substrate layer.

In some embodiments, the deposition process may be carried out in a plurality of ways, e.g., magnetron sputtering, MOCVD, etc. In some embodiments, the electrode layer may also be affixed to the material of the substrate layer. A variety of glues such as acrylate glue, composite structural glue, polymer glue, etc. may be used in the affixing process. In some embodiments, the electrode layer may be of a conductive material. Exemplary conductive materials may include copper (Cu), platinum (Pt), iron (Fe), carbon (C), graphite, etc., or any combination thereof. In some embodiments, allow the sub-cracks (e.g., the first sub-cracks arranged along the first direction and the second sub-cracks arranged along the second direction) to be easily closed during preparation or manufacturing of the substrate layer and to be easily opened under deformation of the substrate layer, a ratio of a thickness of the substrate layer to a thickness of the electrode layer may be within a range of 1:1-100:1 For example, the ratio of the thickness of the substrate layer to the thickness of the electrode layer may be within a range of 2:1-50:1. As another example, the ratio of the thickness of the substrate layer to the thickness of the electrode layer may be within a range of 2:1-20:1.

In 530, the electrode layer may be patterned to form a crack structure in the electrode layer.

In some embodiments, the patterning process refers to a process that relies on a series of masking and etching operations to print graphics. Manners of patterning may include but are not limited to, photolithography, etching, etc. Further descriptions regarding the crack structure may be found in FIG. 2 and related descriptions thereof.

In 540, the substrate layer may be shrunk to reduce a dimension of the crack structure in the electrode layer.

The shrinkage process refers to a related operation that may make an object smaller in dimension. In some embodiments, the material of the substrate layer may be shrunk under certain process conditions (e.g., extrusion, reduced temperature, etc.) to reduce the dimension of the crack structure in the electrode layer. In some embodiments, a tensile stress in operation 510 may be removed to allow for the shrinkage of the substrate layer, which in turn may reduce the dimension of the crack structure in the electrode layer. In some embodiments, to ensure that the sub-cracks may be closed after removing the tensile stress during the preparation or manufacturing of the substrate layer, in the patterning process of the electrode layer, a ratio of a maximum width of each sub-crack in a part of the plurality of sub-cracks to a length of the substrate layer may be less than or equal to a tensile strain pre-applied to the substrate layer in operation 510. For example, the ratio of the maximum width of each sub-crack in a part of the plurality of sub-cracks to the length of the substrate layer may be less than or equal to the tensile strain pre-applied to the substrate layer in operation 510.

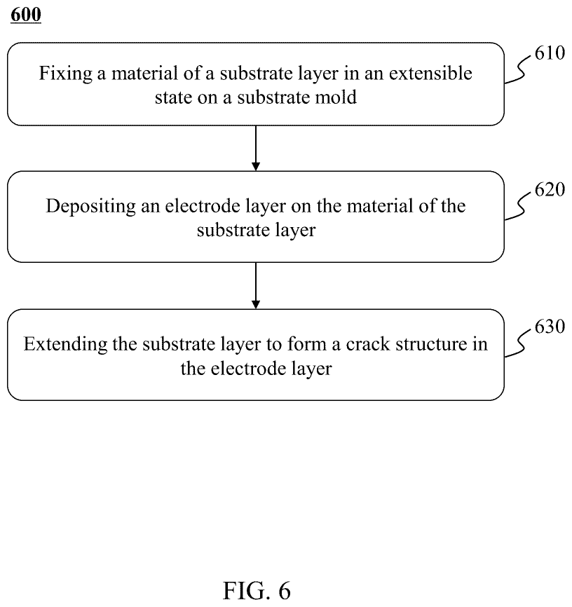

FIG. 6 is a flowchart illustrating an exemplary method for manufacturing a sensor according to some embodiments of the present disclosure. As shown in FIG. 6, process 600 includes the following operations.

In 610, a material of a substrate layer may be fixed in an extensible state on a substrate mold. In some embodiments, the material of the substrate layer may be fixed to the substrate after shrinking. In some embodiments, the material of the substrate layer in the extensible state under certain process conditions (e.g., stretching, increased temperature, etc.) may be selected to be fixed on the substrate mold.

In some embodiments, the material of the substrate layer may have a Young's modulus. In some embodiments, the Young's modulus of the material of the substrate layer may be within a range of 1 kPa-50 GPa. For example, the Young's modulus of the material of the substrate layer may be within a range of 100 kPa-20 GPa. As another example, the Young's modulus of the material of the substrate layer may be within a range of 500 kPa-5 GPa. In some embodiments, the substrate layer may be a flexible material. For example, the material of the substrate layer may include polyimide (PI), polydimethylsiloxane (PDMS), polymethylmethacrylate (PMMA), etc., or any combination thereof.

In some embodiments, the substrate mole refers to a mold used in constructing the substrate layer. In some embodiments, the substrate mold may be determined based on a structure of the substrate layer. For example, if the substrate layer is of a plate-like structure, a mold that allows a finished product to be the plate-like structure may be selected as the substrate mold.

In 620, an electrode layer may be deposited on the material of the substrate layer. In some embodiments, the electrode layer may have different thicknesses at different locations in a first direction (e.g., a length direction or a radial direction of the substrate layer) to allow for the formation of a crack structure at a location with smaller thickness or to more easily increase a dimension of the crack structure compared to a location with larger thickness during subsequent extension process. Descriptions regarding operation 620 may be found in the descriptions related to operation 520 of FIG. 5 in the present disclosure and are not described herein.

In 630, the substrate layer may be extended to form the crack structure in the electrode layer.

The extension process refers to a related operation that may make an object larger in dimension. In some embodiments, the material of the substrate layer may be extended under certain process conditions (e.g., stretching, increased temperature, etc.) to form the crack structure in the electrode layer. In some embodiments, a shrinkage stress in operation 610 may be removed to allow the substrate layer to extend, which in turn may form the crack structure in the electrode layer.

In some embodiments, to avoid a stress concentration caused by the extension of the crack structure, which may in turn lead to damage to the sensor 200, sub-cracks (e.g., the first sub-cracks arranged along the first direction and the second sub-cracks arranged along the second direction) in the crack structure may be extended in an extension direction of the substrate layer 210, i.e., the sub-cracks are extended in the same direction as the substrate layer 210.

FIG. 7 is a diagram illustrating a top view of an exemplary electrode layer according to some embodiments of the present disclosure. In some embodiments, the substrate layer 210 may have different structures. For illustrative purposes, FIG. 7 may be illustrated with an example of the substrate layer 210 of the sensor 200 being a beam-like structure. A first direction may be a length direction (i.e., a long axis direction) of the substrate layer 210 and a second direction may be a width direction (i.e., a short axis direction) of the substrate layer 210. The electrode layer 220 may be arranged on the substrate layer 210, and the substrate layer 210 may be extended in the first direction. The electrode layer 220 may be arranged with a crack structure 230. In some embodiments, the crack structure 230 may include a plurality of sub-cracks arranged at intervals along the first direction and/or the second direction. For example, as shown in FIG. 7, the crack structure 230 may include a plurality of first sub-cracks arranged at intervals along the first direction and a plurality of second sub-cracks arranged at intervals along the second direction, respectively, such as the sub-crack 230-1, the sub-crack 230-2, etc. The plurality of first sub-cracks may be uniformly distributed in the first direction and the plurality of second sub-cracks may be uniformly distributed in the second direction. In some embodiments, a distance between two adjacent sub-cracks (a distance between centers of two adjacent sub-cracks (e.g., the first sub-cracks or the second sub-cracks)) along the first direction (or the second direction) may be the same. The distance between two adjacent sub-cracks along the first direction may be the same, as shown in FIG. 7. In some embodiments, the centers of the sub-cracks refer to geometric centers of projection shapes of the sub-cracks on a surface of the electrode layer 220. In some embodiments, as shown in FIG. 7, each sub-crack (e.g., the sub-crack 230-1 or the sub-crack 230-2) of the plurality of sub-cracks may extend in the first direction, and the plurality of sub-cracks (e.g., the sub-crack 230-1 or the sub-crack 230-2) may be rectilinear in an extension direction thereof (i.e., the first direction). In some embodiments, lengths of the plurality of sub-cracks (e.g., the sub-crack 230-1 or the sub-crack 230-2) in the extension direction (i.e., the first direction) may be equal to a length of the electrode layer 220 at a corresponding location in the first direction, i.e., the plurality of sub-cracks may run through the entire electrode layer 220. In some embodiments, the lengths of the plurality of sub-cracks (e.g., the sub-crack 230-1 or the sub-crack 230-2) in the extension direction (i.e., the first direction) may be less than the length of the electrode layer 220 at the corresponding location in the first direction. As shown in FIG. 7, there may be a plurality of sub-cracks distributed in the first direction of the electrode layer 220, and each sub-crack in the plurality of sub-cracks may have a length in the first direction that is less than the length of the electrode layer 220 in the first direction. In some embodiments, each sub-crack in a part of the plurality of sub-cracks may or may not have the same width along the second direction. FIG. 7 shows that the width of the sub-crack 230-1 along the second direction and the width of the sub-crack 230-2 along the second direction may be the same. In some embodiments, the sub-cracks (e.g., the sub-crack 230-1 or the sub-crack 230-2) may have the same or varying widths along the second direction in the extension direction (i.e., the first direction). As shown in FIG. 7, in the case of sub-crack 230-1, the width of the sub-crack 230-1 along the second direction may be the same. It should be understood that the electrode layer 220 shown in FIG. 7 is only an example and does not limit the scope of protection of the present disclosure.

In some embodiments, the electrode layer 220 of the sensor 200 shown in FIG. 7 may be made by using a material of a negative Poisson's ratio. As shown in FIG. 7, the sub-cracks extend in the first direction. When the substrate layer 210 undergoes a tensile deformation in the first direction, the material of the substrate layer 210 undergoes an expansive deformation in the second direction, and the sub-cracks (e.g., the sub-crack 230-1 or the sub-crack 230-2) in the crack structure 230 are compressed together, resulting in the dimension of the crack structure decreasing, which changes the electrical resistance of the electrode layer 220 and generates a sensing signal changing with the electrical resistance.

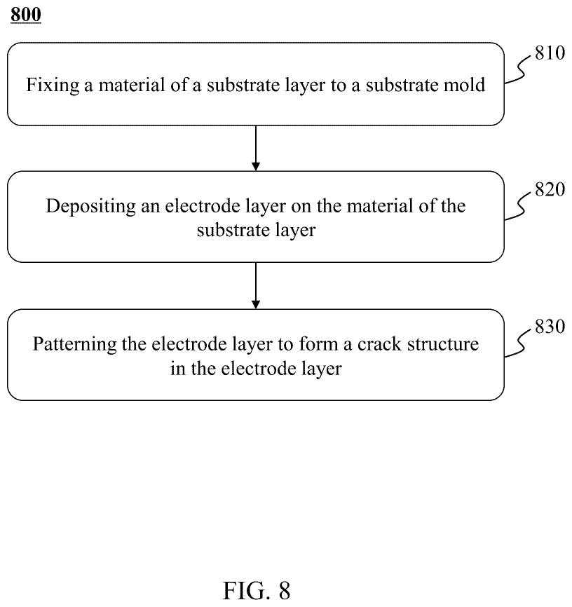

FIG. 8 is a flowchart illustrating an exemplary method for manufacturing a sensor according to some embodiments of the present disclosure. As shown in FIG. 8, process 800 includes the following operations.

In 810, a material of a substrate layer may be fixed to a substrate mold.

In some embodiments, the material of the substrate layer may be a material having a negative Poisson's ratio.

In some embodiments, the substrate mold refers to a mold used in constructing the substrate layer. In some embodiments, the substrate may be determined based on a structure of the substrate layer. For example, if the substrate layer is of a plate-like structure, a mold that allows a finished product to be the plate-like structure may be selected as the substrate mold.

In 820, an electrode layer may be deposited on the material of the substrate layer.

In 830, the electrode layer may be patterned to form a crack structure in the electrode layer. Descriptions regarding operation 820 and operation 830 may be found in the related descriptions of operation 520 and operation 530 in FIG. 5 of the present disclosure and are not described herein.

In some embodiments, the material with the negative Poisson's ratio may undergo extension (or expansion) deformation in a direction perpendicular to an extension direction during tensile deformation, and thus no deformation (e.g., extension or contraction) process of the substrate layer may be required during preparation or manufacturing.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of the present disclosure are not necessarily all referring to the same embodiment. In addition, some features, structures, or features in the present disclosure of one or more embodiments may be appropriately combined.

In addition, it may be appreciated by those skilled in the art that aspects of the present disclosure may be illustrated and described by several patentable varieties or circumstances, including any new and useful process, machine, product, or combination of substances, or any of their new and useful improvements. Accordingly, all aspects of the present disclosure may be performed entirely by hardware, may be performed entirely by softwares (including firmware, resident softwares, microcode, etc.), or may be performed by a combination of hardware and softwares. The above hardware or softwares can be referred to as “data block”, “module”, “engine”, “unit”, “component” or “system”. In addition, aspects of the present disclosure may appear as a computer product located in one or more computer-readable media, the product including computer-readable program code.

A computer storage medium may include a propagation data signal with a computer program encoded within it, e.g., on a baseband or as part of a carrier. The propagation data signal may have a variety of manifestations, including an electromagnetic form, an optical form, or the like, or suitable combinations thereof. The computer storage medium may be any computer-readable medium, other than a computer-readable storage medium, which may be used by connecting to an instruction-executing system, device, or apparatus for communicating, propagating, or transmitting for use. The program code in the computer storage medium may be disseminated via any suitable medium, including radio, cable, fiber optic cable, RF, or the like, or any combination thereof.

The program code required for the operation of the various portions of the present disclosure may be written in any one or a plurality of programming languages, including object-oriented programming languages such as Java, Scala, Smalltalk, Eiffel, JADE, Emerald, C++, C #, VB.NET, Python, etc., conventional procedural programming languages such as C, Visual Basic, Fortran 2003, Perl, COBOL 2002, PHP, ABAP, dynamic programming languages such as Python, Ruby and Groovy, or other programming languages. The program code may be run entirely on the user's computer, or as a stand-alone package on the user's computer, or partially on the user's computer and partially on a remote computer, or entirely on a remote computer or server. In the latter case, the remote computer may be connected to the user's computer through any form of network, such as a local area network (LAN) or wide area network (WAN), or connected to an external computer (e.g., via the Internet), or in a cloud computing environment, or used as a service such as software as a service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes. History application documents that are inconsistent or conflictive with the contents of the present disclosure are excluded, as well as documents (currently or subsequently appended to the present specification) limiting the broadest scope of the claims of the present disclosure. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized according to the teachings herein. Accordingly, embodiments of the present disclosure are not limited to that precisely as shown and described.

1. A sensor, comprising:
a substrate layer configured to deform in response to an external force; and
an electrode layer arranged on the substrate layer, wherein
the electrode layer includes a crack structure, and
a deformation of the substrate layer changes a dimension of the crack structure to change an electrical resistance of the electrode layer and to generate a sensing signal changing along with the electrical resistance.

2. The sensor of claim 1, wherein the substrate layer extends along a first direction, and the crack structure includes a plurality of first sub-cracks arranged at intervals along the first direction.

3. The sensor of claim 1, wherein the substrate layer extends along a first direction, the crack structure includes a plurality of second sub-cracks arranged at intervals along a second direction, each second sub-crack of the plurality of second sub-cracks extends along the first direction, and the second direction is perpendicular to the first direction.

4. The sensor of claim 3, wherein the crack structure further includes a plurality of first sub-cracks distributed along the first direction.

5. The sensor of claim 2, wherein the plurality of first sub-cracks are non-uniformly distributed in the first direction.

6. The sensor of claim 2, wherein a total count of the plurality of first sub-cracks is within a range of 10-10000.

7. The sensor of claim 2, wherein the substrate layer has a beam-like structure or a plate-like structure, and the first direction is a length direction of the substrate layer.

8. The sensor of claim 2, wherein the substrate layer has a circular membrane-like structure, and the first direction is a radial direction of the substrate layer.

9. The sensor of claim 2, wherein each first sub-crack in a part of the plurality of first sub-cracks has a varying width in an extension direction.

10. The sensor of claim 9, wherein the width of the each first sub-crack of a part of the plurality of first sub-cracks is within a range of 100 nanometers-3 micrometers.

11. The sensor of claim 9, wherein a ratio of a maximum width of the each first sub-crack of a part of the plurality of first sub-cracks to a length of the substrate layer is less than or equal to a tensile strain of the substrate layer during preparation.

12. The sensor of claim 2, wherein the electrode layer is electrically connected to two output ends, and an included angle between a line connecting the two output ends and an extension direction of the each first sub-crack is within a range of 80 degrees-100 degrees.

13. The sensor of claim 2, wherein the each first sub-crack of a part of the plurality of first sub-cracks is of a curved shape in an extension direction.

14. The sensor of claim 1, wherein the electrical resistance of the electrode layer varies nonlinearly with the dimension of the crack structure.

15. The sensor of claim 1, wherein the electrode layer includes a material including a first Young's modulus, and the substrate layer includes a material including a second Young's modulus, wherein
the second Young's modulus does not exceed 1/10 of the first Young's modulus.

16. The sensor of claim 1, wherein a ratio of a thickness of the electrode layer to a thickness of the substrate layer is within a range of 1:20-1:2.

17. A method for manufacturing a sensor, comprising:
fixing a material of a substrate layer in a shrinkable state on a substrate mold;
depositing an electrode layer on the material of the substrate layer;
patterning the electrode layer to form a crack structure in the electrode layer; and
shrinking the substrate layer to reduce a dimension of the crack structure in the electrode layer.

18. The method of claim 17, wherein the method is used to manufacture a sensor comprising:
a substrate layer configured to deform in response to an external force; and
an electrode layer arranged on the substrate layer, wherein
the electrode layer includes a crack structure, and
a deformation of the substrate layer changes a dimension of the crack structure to change an electrical resistance of the electrode layer and to generate a sensing signal changing along with the electrical resistance.

19. A method for manufacturing a sensor, comprising:
fixing a material of a substrate layer in an extensible state on a substrate mold;
depositing an electrode layer on the material of the substrate layer; and
extending the substrate layer to form a crack structure in the electrode layer.

20. The method of claim 19, wherein the method is used to manufacture a sensor comprising:
a substrate layer configured to deform in response to an external force; and
an electrode layer arranged on the substrate layer, wherein
the electrode layer includes a crack structure, and
a deformation of the substrate layer changes a dimension of the crack structure to change an electrical resistance of the electrode layer and to generate a sensing signal changing along with the electrical resistance.

21-22. (canceled)
